(19) United States
(12) Patent Application Publication
(10) Pub. No.: US 2014/0034711 A1
(43) Pub. Date: Feb. 6, 2014

(54) PRESSING A WELD USING THE FRICTION AGITATION WELDING PROCESS FOR BETTER SURFACE ADJUSTMENT

(71) Applicant: AIRBUS OPERATIONS GMBH, Hamburg (DE)

(72) Inventor: Hartmut Ostersehlte, Bremen (DE)

(73) Assignee: AIRBUS OPERATIONS GMBH, Hamburg (DE)

(21) Appl. No.: 14/051,649

(22) Filed: Oct. 11, 2013

Related U.S. Application Data
(62) Division of application No. 13/598,735, filed on Aug. 30, 2012.
(60) Provisional application No. 61/530,077, filed on Sep. 1, 2011.

(30) Foreign Application Priority Data
Sep. 1, 2011 (DE) 10 2011 112 042.8

(51) Int. Cl. B23K 20/12

(52) U.S. Cl. CPC B23K 20/122
USPC 228/114

(57) ABSTRACT

A friction agitation welding process for the joining of abutting plate-shaped workpieces consisting of an aluminium alloy, wherein a rotating Bobbin tool is moved along a weld between the two plate-shaped workpieces during feed, exerting a first and a second contact pressing force on first and second sides, respectively, and wherein said Bobbin tool is subjected to an additional axial force during its movement along the weld to plastically deform the area of the created welding seam such that the welding seam is pressed towards one side of the plate-shaped workpieces while forming a welding seam elevation protruding opposite from the workpiece surface.

### CROSS-REFERENCE TO RELATED APPLICATIONS

This application is a divisional of U.S. application Ser. No. 13/598,735, filed on Aug. 30, 2012, which application claims the benefit of the filing date of U.S. Provisional Patent Application No. 61/530,077 filed Sep. 1, 2011, the disclosures of which are hereby incorporated herein by reference.

### AREA OF THE INVENTION

The invention relates to a friction agitation welding process for the joining of abutting plate-shaped workpieces, which consist of an aluminium alloy, along their edges, wherein a rotating Bobbin tool is moved between the two plate-shaped workpieces along a weld during feed, exerting a contact pressing force on both sides of the plate-shaped workpieces. Besides that, the invention also relates to a device realizing the friction agitation welding process.

The area of application of the invention extends to industrial processes of production, in which plate-shaped workpieces such as, for example, aluminium sheets are to be integrally joined along their edges. The solution according to an aspect of the present invention is particularly applicable in aircraft construction in the process of joining fuselage shells. Both transverse welds between usually oval fuselage sections and also longitudinal welds in the fuselage area may be manufactured such as an alternative to conventional riveting.

### BACKGROUND OF THE INVENTION

In the friction agitation welding process generally known in the state of the art, a rotating tool is pressed with a great force into the weld between the two workpieces to be joined until a tool shoulder is coming into contact at the surface of the workpiece. Due to the friction between the tool shoulder and the workpieces to be joined, the material below the shoulder is heated, almost reaching the melting point. Said increase in temperature is followed by a weakening, due to which the material is plasticized and a blending of the weld zone is allowed. When the feed movement starts, the rotating tool is moved along the weld exerting a high contact pressing force. The pressure gradient between the front side and the rear side of the tool created by means of the feed movement and by its rotational movement effect the transport of plasticised material around the tool, which blends there and forms a welding seam. At the end of the feed, the rotating tool is removed out of the weld zone. As friction agitation welding, in contrast to conventional fusion welding processes, occurs at temperatures below the melting point of light metal alloys, disadvantageous changes in the microstructure during the solidification of the melt are avoided. Due to this fact, also the higher strength aluminium alloys used in aerospace, which are usually regarded as being not easily weldable, may be welded without filler materials and without great losses of strength.

In particular during the process of friction agitation welding of the transversal seam between adjacent fuselage sections, one encounters the problem that on the insides of the fuselage sections no counter support can be installed, which would receive the contact pressing force to be generated by the tool. In such cases of application, therefore, particular tools are applied, which are referred to as Bobbin tools, in which the tool shoulder generating the contact pressure corresponds with an opposing shoulder that is integrated into the tool.

U.S. Pat. No. 6,758,382 B1 discloses a Bobbin tool of this kind to perform the friction agitation welding process. The Bobbin tool essentially comprises an upper shoulder part, which may be put in a rotational movement, which corresponds with a lower shoulder part, which works as a counter support for the contact pressing force onto the workpiece surface generated by the upper shoulder part. The lower shoulder part is fastened to a pin, which is both rotatable to perform friction agitation welding, and also axially adjustable to adjust the contact pressing force of the upper shoulder part to the workpiece while co-acting with the lower shoulder part. An adjustment of the contact pressing force to other process parameters is carried out by means of corresponding sensor elements to measure the actual states of the process, which are then analysed by an electronic control unit. Following analysis, the process parameters such as feed, contact pressing force, and rotational speed of the tool are controlled.

It is a disadvantage of friction agitation welding applying a Bobbin tool that characteristic welding marks are created on both sides of the workpiece, which present themselves as semicircular striae. These should, if possible, be smoothened, levelled, or removed in the visible parts of the workpieces, or for static reasons. However, if said characteristic welding marks were removed by a chip-generating process step such as milling or grinding, the required material thickness at the position of the welding seam could fall below a minimum threshold as a consequence of the removal of material.

### BRIEF SUMMARY OF THE INVENTION

An aspect of the present invention provides a process and a device for joining adjacent plate-shaped workpieces comprising an aluminium alloy by means of the friction agitation welding process, which allows the removal of characteristic welding marks without the local material thickness falling below a minimum threshold.

An aspect of the invention includes the process-related teaching that the Bobbin tool, during its movement along the weld, is subjected to an additional axial force Fₓ to plastically deform the area of the created welding seam such that it is pushed or pulled towards one side of the plate-shaped workpieces while forming a welding seam elevation protruding opposite of the workpiece surface. With respect to device technology, means for subjecting the Bobbin tool with the additional axial force (Fₓ) during the movement along the weld are provided. Said means may comprise, for example, a hydraulic cylinder acting on the tool support head, or an electric linear actuator.

In other words, the Bobbin tool, therefore, is adjusted such that part of the material is shifted to the one side of the plate-shaped workpieces during welding. The welding seam elevation created such may subsequently be levelled, for example, by milling or grinding such that a level surface is obtained at least at the one side of the plate-shaped workpieces such joined.

Preferably, as an additional axial force Fx, a traction force is exerted onto the Bobbin tool in order to shift the welding seam elevation towards the one side of the plate-shaped workpieces. As an alternative to this, it is, however, also conceivable to exert the axial force Fₓ as a force down onto the Bobbin tool, provided this corresponds to the process requirements, and the desired welding seam elevation according to an embodiment of the invention may be created such in a controlled manner. In doing so, the additional axial force (Fₓ) may be adjusted depending on the desired position of the welding seam elevation.

According to another aspect of the invention, an increase in material thickness running on both sides of the weld is provided on the opposite side of the welding seam elevation of the plate-shaped workpieces. Said increase in material thickness provides a material reservoir in order to avoid the indentation resulting from the pressing of the welding seam which would occur otherwise at this side of the workpieces. If, according to a preferred form of embodiment, the plate-shaped workpieces to be joined show a material thickness of from between 2 and 8 mm, the material thickness increase should amount between 1.5 and 2 times the material thickness in order to obtain the intended balancing of material.

According to another preferred process parameter, the additional axial force Fₓ acting on the Bobbin tool during the movement along the weld should be dimensioned such that the welding seam elevation protrudes from between 0.1 and 0.5 mm from the surface of the workpiece. This relatively small welding seam elevation is sufficient to remove the characteristic welding marks in the following process step without leaving any residue.

In case the plate-shaped workpieces embody exterior skin plates of an aircraft fuselage, the increase in material thickness is, preferably, positioned on the inside of the fuselage and the welding seam elevation is positioned on the outside of the fuselage, because due to the subsequent removal of the welding marks the exterior visible area of the aircraft fuselage can be embodied with a smooth surface. Besides obtaining this optical advantage, by means of the removal of the welding marks also material notches are removed to increase the fatigue strength of the joint. Furthermore, the aerodynamic properties of the aircraft fuselage are improved.

### BRIEF DESCRIPTION OF THE DRAWINGS

Further aspects of the invention are described in more detail in the following by means of the figures together with a description of a preferred example of an embodiment of the invention. The following is shown:

FIG. 1 a schematic representation of a Bobbin tool in engagement with the plate-shaped workpieces to be joined,

FIG. 2 a cross-sectional representation of the two abutting plate-shaped workpieces to be joined before friction agitation welding,

FIG. 3 the two plate-shaped workpieces according to FIG. 2 after friction agitation welding, and

FIG. 4 the two plate-shaped workpieces according to FIG. 3 after the removal of the welding seam elevation.

### DETAILED DESCRIPTION

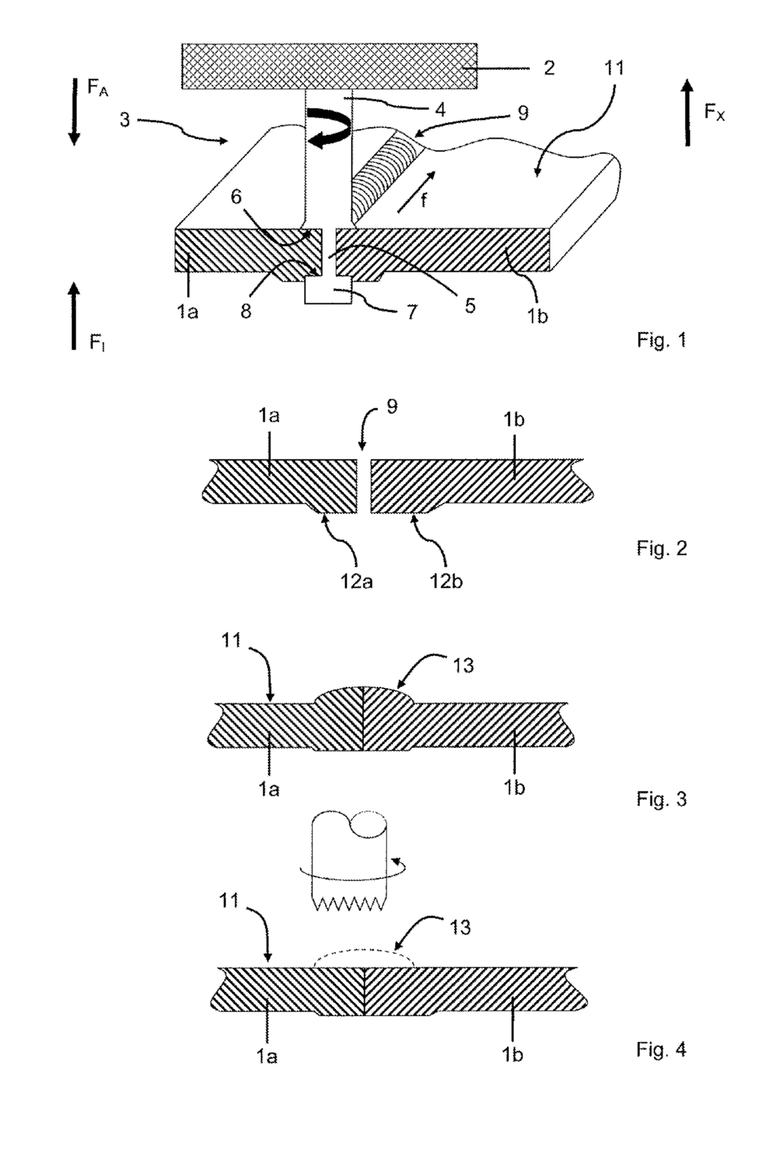

According to FIG. 1, an arrangement for the joining of two abutting plate-shaped workpieces 1a and 1b of aluminium comprises a Bobbin tool 3 driven by an electronically controlled engine 2, which is composed of a plurality of parts.

The Bobbin tool 3 essentially comprises a tool shank 4, at the distal end of which a pin section 5 of a lesser diameter relative to it is arranged. Between the tool shank 4 and the pin section 5 an upper tool shoulder 6 is formed. On the side of the distal end of the pin section 5, an end part 7 is arranged as a counter support, which has a larger diameter in relation to it, which forms a lower tool shoulder 8.

The tool shank 4 is put into a rotational movement by the engine 2 with the pin section 5, by means of which heat is entered into the workpieces 1a and 1b to perform friction agitation welding along a weld 9 between the two workpieces 1a and 1b. By means of simultaneous axial pressing of the lower tool shoulder 8 as well as of the upper tool shoulder 6 onto the surface of the workpieces 1a and 1b, an additional contact pressing force is exerted onto the surface of the workpiece, generating additional thermal energy.

An additional axial force Fₓ is exerted onto the Bobbin tool 3 during the movement effected by the feed f along the weld 9, which is also generated by the engine 2, in order to plastically deform the area of the welding seam 10 created by friction agitation welding such that it deforms thus forming a welding seam elevation protruding opposite of the workpiece surface 11 in the direction of the axial force Fₓ.

According to FIG. 2, increases in material thickness 12a and 12b are provided at one side of the plate-shaped workpieces 1a and 1b within the area of the weld 9, which correspond to approximately between 1.5 and two times the material thickness of the two plate-shaped workpieces 1a and 1b. Said increases in material thickness 12a and 12b form a material reservoir to the end that on the opposite side of the plate-shaped workpieces 1a and 1b a welding seam elevation 13 is created, as can be seen in FIG. 3.

The welding seam elevation 13 protrudes up to 0.5 mm from the surface of the workpiece 11 of the two plate-shaped workpieces 1a and 1b. Through application of a force in the axial direction onto the Bobbin tool 3, which is not further shown, the area of material around the welding seam is shifted towards the upper side of the plate-shaped workpieces 1a and 1b by means of the welding seam elevation 13, in order to subsequently remove it according to FIG. 4.

The welding seam elevation 13 is removed by means of a chip removing tool 14, which is embodied here as a sort of milling tool, and which creates a smooth workpiece surface 11 between the two integrally joined workpieces 1a and 1b after milling of the welding seam elevation 13.

The invention is not restricted to the preferred example of embodiment described above. In fact, also deviations thereof are conceivable, which are covered by the scope of protection of the following claims. For example, it is also possible that the welding seam elevation 13 is not created by a pulling movement of the Bobbin tool 3, but by a force down movement of the Bobbin tool 3 during the process of friction agitation welding.

1. A friction agitation welding process for the joining of first and second abutting plate-shaped workpieces comprising an aluminium alloy, the process comprising:
moving a rotating Bobbin tool along a weld between the first and second plate-shaped workpieces during a feed (f) while exerting a first and a second contact pressing force on a first and a second side, respectively,
wherein the Bobbin tool is subjected to an axial force during the movement along the weld to plastically deform the area of the created welding seam such that the welding seam is pressed towards one side of the plate-shaped workpieces while forming a welding seam elevation protruding opposite the workpiece surface.

2. The friction agitation welding process according to claim 1, wherein a traction force is exerted onto the Bobbin tool as the axial force to press the welding seam elevation towards one side of the plate-shaped workpieces.

3. The friction agitation welding process according to claim 1, wherein the welding seam elevation positioned towards one side of the plate-shaped workpieces is at least partly removed by a chip-removing tool to obtain a level workpiece surface.

4. The friction agitation welding process according to claim 1, wherein the axial force is adjusted depending on the desired position of the welding seam elevation.

5. The friction agitation welding process according to claim 1, wherein the axial force acting on the Bobbin tool during the movement along the weld is dimensioned such that the welding seam elevation protrudes between 0.1 and 0.5 millimetres from the workpiece surface.

6. The friction agitation welding process according to claim 1, wherein the first and second plate-shaped workpieces having a material thickness of from between 2 and 8 millimetres are dimensioned with an increase in material thickness of between 1.5 and 2 times the material thickness.
